(19) United States
(12) Patent Application Publication
(10) Pub. No.: US 2018/0101553 A1
(43) Pub. Date: Apr. 12, 2018

(54) INFORMATION PROCESSING APPARATUS, DOCUMENT ENCODING METHOD, AND COMPUTER-READABLE RECORDING MEDIUM

(71) Applicant: FUJITSU LIMITED, Kawasaki-shi (JP)

(72) Inventors: Fumiaki NAKAMURA, London (GB); Masahiro KATAOKA, Kamakura (JP); Seiji OKURA, Meguro (JP); Masao IDEUCHI, Hachioji (JP)

(73) Assignee: FUJITSU LIMITED, Kawasaki-shi (JP)

(21) Appl. No.: 15/714,205

(22) Filed: Sep. 25, 2017

(30) Foreign Application Priority Data
Oct. 7, 2016 (JP) 2016-199255

(51) Int. Cl. G06F 17/30

(52) U.S. Cl. CPC G06F 17/30321

(57) ABSTRACT

A non-transitory computer-readable recording medium stores a document encoding program that causes a computer to execute a process including: first generating index information in which an appearance position is associated with each word appearing on document data of a target as bit map data at the time of encoding the document data of the target in word unit; second generating document structure information in which a relationship with respect to the appearance position included in the index information is associated with each specific sub structure included in the document data as bit map data; and retaining the index information and the document structure information in a storage in association with each other.

### CROSS-REFERENCE TO RELATED APPLICATION

This application is based upon and claims the benefit of priority of the prior Japanese Patent Application No. 2016-199255, filed on Oct. 7, 2016, the entire contents of which are incorporated herein by reference.

### FIELD

The embodiment discussed herein is related to a document encoding method and the like.

### BACKGROUND

There is a method in which frequencies of words used for a document of an analysis target are aggregated, cluster analysis or measurement of a distance (measurement of a similarity ratio) between documents based on a frequency aggregation result is performed. In the measurement of the similarity ratio between the documents, it is possible to search a document similar to a certain document. In such searching, as with the presence or absence of the similar document or the similarity ratio between the documents, it is possible to search a particularly similar sub structure in a plurality of sub structures of the similar document.

In addition, it is known that the aggregation of the frequencies of the words is performed in document unit.

Japanese Laid-open Patent Publication No. 2003-157271

Japanese Laid-open Patent Publication No. 2001-249943

Japanese Laid-open Patent Publication No. 6-28403

However, in a case where the analysis target is segmentalized, and analysis is performed in the unit of the sub structure of the document, there is a problem that it is not possible to use a processing result of performing processing in the document unit. For example, in a case where the analysis target is segmentalized, and a similarity ratio with respect to a specific searching query (a searching sentence) is measured in the unit of the sub structure of the document, the frequencies of the words are newly aggregated in the unit of the sub structure. That is, the frequencies of the words are aggregated in the document unit, and frequencies of the words are newly aggregated in the unit of the sub structure, which is segmentalized aggregation unit. Furthermore, examples of the unit of the sub structure include chapter unit, clause unit, and the like.

Here, the program that it is not possible to use the processing result of performing the processing in the document unit in a case where the analysis is performed in the unit of the sub structure of the document will be described with reference to FIG. 1 and FIG. 2.

FIG. 1 is a diagram illustrating an example of a flow of document processing utilizing compressed data. As illustrated in FIG. 1, an information processing apparatus expands compressed data of a compressed document (a1), and performs lexical analysis with respect to the expanded document data (a2). Then, the information processing apparatus aggregates appearance frequencies of words of a lexical analysis result (a3). Then, the information processing apparatus utilizes an aggregation result, and performs analysis (a4). The compressed data, for example, is data which is compressed by ZIP. Then, in a case where the analysis is performed in the unit of the sub structure of the document, the information processing apparatus newly expands the compressed data of the compressed document (a1), and performs the lexical analysis with respect to the expanded document data (a2). Then, the information processing apparatus aggregates the appearance frequencies of the words of the lexical analysis result according to the sub structure (a3). Then, the information processing apparatus utilizes the aggregation result, and performs the analysis (a4). That is, in a case where the analysis is performed in the unit of the sub structure of the document, it is not possible for the information processing apparatus to use the document data at the time of expanding the compressed data and the lexical analysis result at the time of performing the lexical analysis.

FIG. 2 is a diagram illustrating an example of the flowchart of the document processing utilizing the compressed data. Furthermore, in FIG. 2, a case of utilizing the measurement of a similarity ratio between a specified searching query and a document in sub structure unit will be described. As illustrated in FIG. 2, in a case where the analysis is performed in the unit of the sub structure of the document, the information processing apparatus expands the document which is compressed by ZIP (S101). The expanded document data is divided in the sub structure unit by a user (S102). Then, the information processing apparatus performs the lexical analysis with respect to each of the divided document and the searching query (S103). The information processing apparatus aggregates the number of appearances of the words of the lexical analysis result (S104). Then, the information processing apparatus determines whether or not the analysis of a TF/IDF value is used (S105). Furthermore, the TF/IDF represents an important degree relevant to the word in the document, and is represented from a term frequency (TF) value representing an appearance frequency of the word in the document and an inverse document frequency (IDF) value representing how many words are commonly used in the document. Then, in a case where the TF/IDF value is not used (S105; No), the information processing apparatus calculates the similarity ratio by using the frequency aggregation result of the word of each sub structure as input data (S106). On the other hand, in a case where the TF/IDF value is used (S105; Yes), the information processing apparatus converts the number of appearances of the words of the document of the target and the searching query into the TF/IDF value (S107), and calculates the similarity ratio by using the TF/IDF value as the input data (S108). Examples of the similarity ratio include a Mahalanobis distance, a jaccard distance, or a cosine distance. Then, the information processing apparatus, for example, displays a sub structure having a short distance with respect to the searching query in rank order (S109).

Thus, in a case where the analysis is performed in the unit of the sub structure of the document, it is not possible for the information processing apparatus to use the processing result of performing the processing in the document unit.

### SUMMARY

According to an aspect of the embodiment, a non-transitory computer-readable recording medium stores a document encoding program that causes a computer to execute a process including: first generating index information in which an appearance position is associated with each word appearing on document data of a target as bit map data at the time of encoding the document data of the target in word unit; second generating document structure information in which a relationship with respect to the appearance position included in the index information is associated with each specific sub structure included in the document data as bit map data; and retaining the index information and the document structure information in a storage in association with each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a flow of document processing utilizing compressed data;

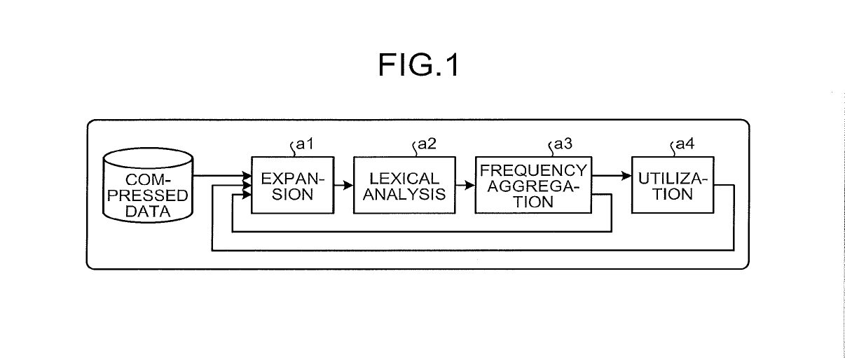

FIG. 2 is a diagram illustrating an example of the flowchart of the document processing utilizing the compressed data;

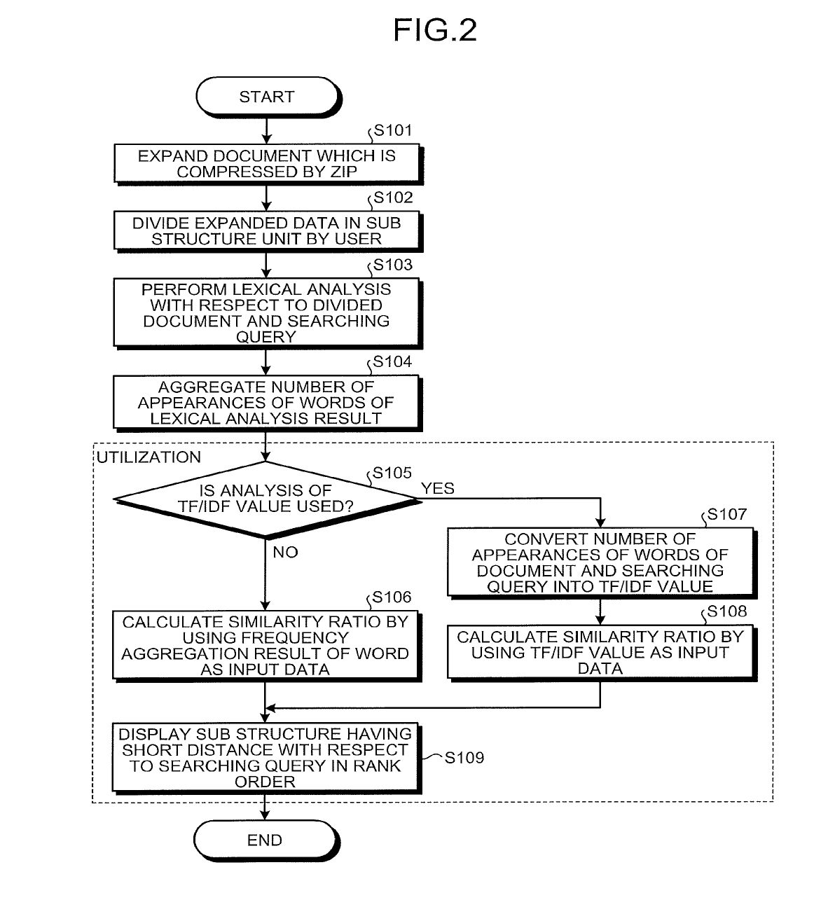

FIG. 3 is a diagram illustrating an example of a flow of document processing according to a first example;

FIG. 4 is a functional block diagram illustrating a configuration of an information processing apparatus according to the first example;

FIG. 5 is a diagram illustrating an example of a data structure of a bit map type index according to the first example;

FIG. 6 is a diagram illustrating an example of aggregation granularity specifying processing according to the first example;

FIG. 7 is a diagram illustrating an example of frequency aggregation processing according to the first example;

FIG. 8 is a diagram illustrating an example of a flowchart of index generating processing according to the first example;

FIG. 9 is a diagram illustrating an example of a flowchart of document processing according to the first example;

FIG. 10 is a diagram illustrating an example of a flowchart of the frequency aggregation processing according to the first example;

FIG. 11 is a functional block diagram illustrating a configuration of an information processing apparatus according to a second example;

FIG. 12 is a diagram illustrating an example of preprocessing according to the second example;

FIG. 13 is a diagram illustrating an example of a flowchart of document processing according to the second example; and

FIG. 14 is a diagram illustrating an example of a configuration of hardware of the information processing apparatus.

### DESCRIPTION OF EMBODIMENTS

Preferred embodiments will be explained with reference to accompanying drawings. Furthermore, the present invention is not limited by the examples.

### First Example

Example of Flow of Document Processing according to First Example

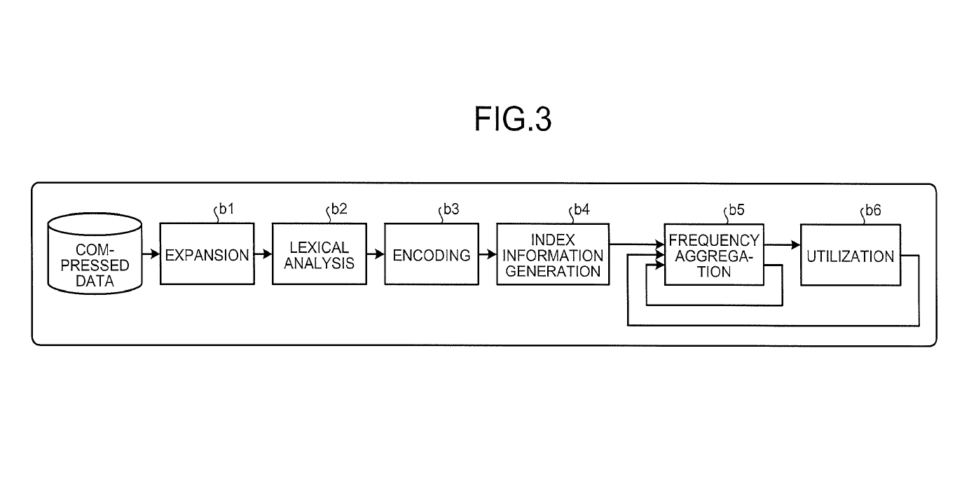

FIG. 3 is a diagram illustrating an example of a flow of document processing according to this example. Furthermore, in the document processing according to the first example, a compression and expansion algorithm will be described as ZIP.

As illustrated FIG. 3, an information processing apparatus expands compressed data of a document which is compressed by ZIP (b1), and performs lexical analysis with respect to the expanded document data by using a dictionary for lexical analysis (b2). Then, the information processing apparatus encodes a word of a lexical analysis result by using a dictionary for encoding (b3). That is, the information processing apparatus allocates a word code with respect to the word. Then, the information processing apparatus generates index information in which an appearance position is associated with each word code of a word appearing on the document data as bit map data. In addition, the information processing apparatus generates document structure information in which a relationship with respect to the appearance position included in the index information is associated with each specific sub structure included in the document data as bit map data (b4). Then, the information processing apparatus aggregates appearance frequencies of the words of the lexical analysis result by using the generated index information and document structure information, according to the sub structure (b5). Then, the information processing apparatus performs analysis by utilizing an aggregation result (b6). Furthermore, examples of the sub structure include a chapter, a clause, or the like in the document data, but are not limited thereto. That is, the sub structure may be explicitly represented in the document data (a paragraph and a line separation), or may be a semantic separation or a separation which is arbitrarily set by a reader. In addition, the dictionary for encoding corresponding to a static dictionary and a dynamic dictionary, described below. The index information and the document structure information correspond to a bit map type index described below.

Then, in a case where the analysis is performed in the unit of the sub structure of the document, the information processing apparatus aggregates the appearance frequencies of the words by using the index information and the document structure information which are generated by a code b4, according to the sub structure (b5). Then, the information processing apparatus performs the analysis by utilizing the aggregation result (b6).

Accordingly, the information processing apparatus uses the index information and the document structure information, and thus, even in a case where the analysis is performed by replacing the unit of the sub structure of the document, the expansion and the lexical analysis are not repeated in each case. That is, in a case where the analysis is performed in the unit of the sub structure of the document, it is possible for the information processing apparatus to use a processing result of performing processing in document unit.

Configuration of Information Processing Apparatus According to First Example

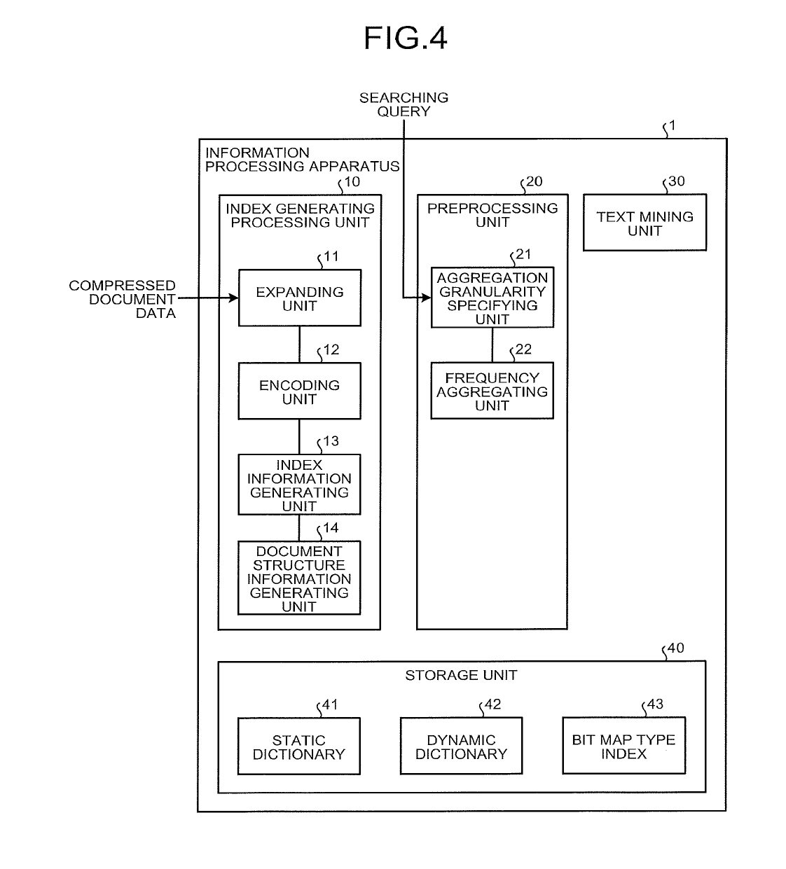

FIG. 4 is a functional block diagram illustrating the configuration of the information processing apparatus according to first example. As illustrated in FIG. 4, an information processing apparatus 1 includes an index generating processing unit 10, a preprocessing unit 20, a text mining unit 30, and a storage unit 40.

The storage unit 40, for example, corresponds to a store apparatus such as a non-volatile semiconductor memory element such as flash memory or a ferroelectric random access memory (FRAM: Registered Trademark). The storage unit 40 includes a static dictionary 41, a dynamic dictionary 42, and a bit map type index 43.

The static dictionary 41 is a dictionary in which an appearance frequency of a word appearing in a document is specified based on a general English dictionary, a general national language dictionary, a general text book, or the like, and a shorter code is allocated with respect to a word having a higher appearance frequency. For example, codes of one byte of “20h” to “3Fh” are allocated with respect to an ultra-high frequency word. Examples of the ultra-high frequency word include the particle such as “as”, “in”, “with”, and “of”. Codes of two bytes of “8000h” to “9FFFh” are allocated with respect to a high frequency word. Examples of the high frequency word include Kana, Katakana, kanji taught in Japanese primary schools, and the like. A static code, which is a code corresponding to each word, is registered in the static dictionary 41 in advance. The static code corresponds to a word code (a word ID).

The dynamic dictionary 42 is a dictionary in which a word, which is not registered in the static dictionary 41, is associated with a dynamic code, which is dynamically assigned. Examples of the word, which is not registered in the static dictionary 41, include a word having a low appearance frequency (a low frequency word). For example, codes of two bytes of “A000h” to “DFFFh” or codes of three bytes of “F00000h” to “FFFFFFh” are allocated with respect to the low frequency word. Here, the low frequency word includes an expert word, a new word, an unknown word, and the like. The expert word is a word which is suitable for a specific academic discipline, business, or the like, and represents a word having a feature of repeatedly appearing in a document to be encoded. The new word is a word which is newly made, such as a vogue word, and represents a word having a feature of repeatedly appearing in a document to be encoded. The unknown word is not an expert word and is a word which is not a new word, and represents a word having a feature of repeatedly appearing in a document to be encoded. Furthermore, the appearing word is associated with the dynamic code, and is registered in the dynamic dictionary 42, in appearance order of the word, which is not registered in the static dictionary 41.

The bit map type index 43 includes the index information and the document structure information. The index information is a bit string in which a pointer designating a word included in document data of a target is coupled to a bit representing the presence or absence in each offset (each appearance position) in the document data of the word. That is, the index information represents a bit map in which the presence or absence of each of the offsets (the appearance positions) is indexed with respect to the word included in the text data of the target. For example, a word ID of the word is adopted as the pointer designating the word. Furthermore, the word itself may be the adopted as the pointer designating the word. The document structure information is a bit string in which a pointer designating a sub structure of various granularities included in the document data of the target is coupled to each offset (each appearance position) in the document data of the sub structure. That is, the document structure information represents a bit map in which the presence or absence of each of the offsets (the appearance positions) is indexed with respect to the sub structure included in the document data of the target.

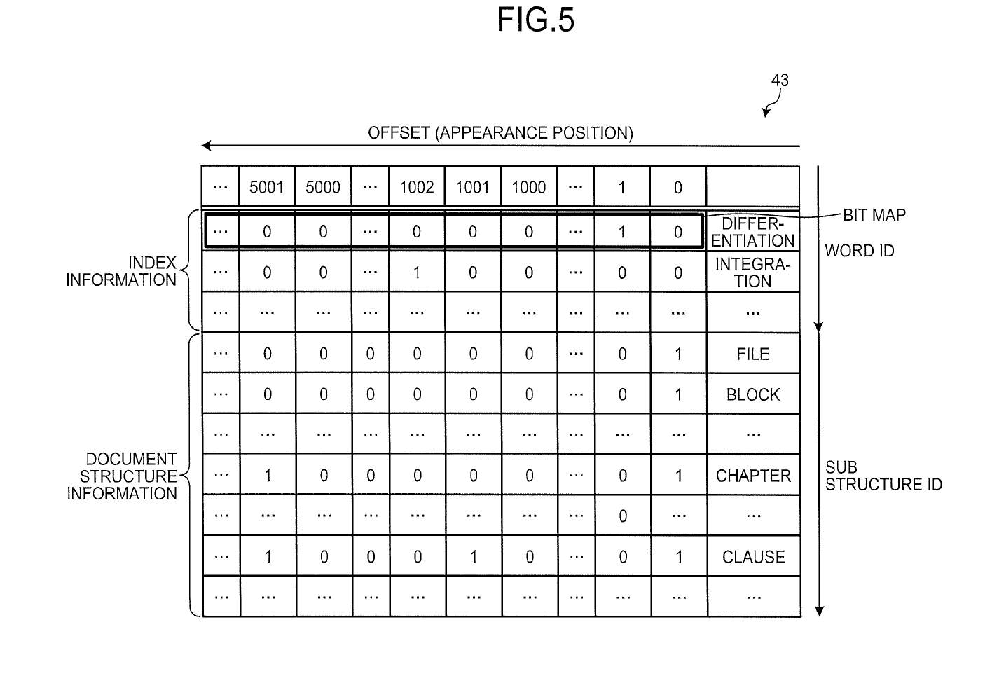

Here, the data structure of the bit map type index 43 will be described with reference to FIG. 5. FIG. 5 is a diagram illustrating an example a data structure of a bit map type index according to the first example. As illustrated in FIG. 5, in the bit map type index 43, an X axis represents an offset (an appearance position), and a Y axis represents a word ID or a sub structure ID. The bit map type index 43 includes the index information and the document structure information. The bit map included in the index information represents the presence or absence of each offset (each appearance position) of the word represented by the word ID. In a case where the word represented by the word ID is in the appearance position in the document data, ON is set as the presence or absence of the offset (the appearance position) corresponding to the appearance position, that is, an appearance bit representing a binary digit of “1” is set. In a case where the word represented by the word ID is not in the appearance position in the document data, OFF is set as the presence or absence of the offset (the appearance position) corresponding to the appearance position, that is, a binary digit of “0” is set. In addition, the bit map included in the document structure information represents the presence or absence of each of the offsets (the appearance positions) of the sub structure represented by the sub structure ID. In a case where the sub structure represented by the sub structure ID is in the document data, ON is set as the presence or absence of the offset (the appearance position) corresponding to the appearance position of the word appearing on the head of the sub structure, that is, an appearance bit representing a binary digit of “1” is set.

As an example, in a case where the word is “differentiation”, an appearance bit of “1” is set to a bit with respect to an appearance position of “1”. In a case where the word is “integration”, the appearance bit of “1” is set to a bit with respect to an appearance position of “1002”. In a case where the granularity of the sub structure is “chapter”, the appearance bit of “1” is set to bits of each of an appearance position of “0” and an appearance position of “5001”. For example, “Chapter 1” is started from the appearance position of “0”, and “Chapter 2” is started from the appearance position of “5001”. In a case where the sub structure is “clause”, the appearance bit of “1” is set to bits of each of the appearance position of “0”, an appearance position of “1001”, and the appearance position of “5001”. For example, “Clause 1” of “Chapter 1” is started from the appearance position of “0”, “Clause 2” of “Chapter 1” is started from the appearance position of “1001”, and “Clause 1” of “Chapter 2” is started from the appearance position of “5001”.

Returning to FIG. 4, the index generating processing unit 10 expands the compressed document data, and generates the bit map type index 43 from the expanded document data. The index generating processing unit 10 includes an expanding unit 11, an encoding unit 12, an index information generating unit 13, and a document structure information generating unit 14.

The expanding unit 11 expands the compressed document data. For example, the expanding unit 11 receives the compressed document data. Then, the expanding unit 11 determines the longest coincidence character string with respect to the received compressed data by using a slide window, based on an expansion algorithm of ZIP, and generates expanded data.

The encoding unit 12 encodes the word included in the expanded document data. For example, the encoding unit 12 performs the lexical analysis with respect to the expanded document data by using the dictionary for lexical analysis. Then, the encoding unit 12 encodes the word to the word ID by using the static dictionary 41 and the dynamic dictionary 42, in the order from a head word of the lexical analysis result. As an example, the encoding unit 12 determines whether or not the word of the lexical analysis result is registered in the static dictionary 41. In a case where the word of the lexical analysis result is registered in the static dictionary 41, the encoding unit 12 encodes the word to the static code (the word ID) by using the static dictionary 41. In a case where the word of the lexical analysis result is not registered in the static dictionary 41, the encoding unit 12 determines whether or not the word is registered in the dynamic dictionary 42. In a case where the word of the lexical analysis result is registered in the dynamic dictionary 42, the encoding unit 12 encodes the word to the dynamic code (the word ID) by using the dynamic dictionary 42. In a case where the word of the lexical analysis result is not registered in the dynamic dictionary 42, the encoding unit 12 registers the word in the dynamic dictionary 42, and encodes the word to the unused dynamic code (word ID) in the dynamic dictionary 42.

The index information generating unit 13 generates the index information in which the appearance position (the offset) is associated with each of the word IDs of the words appearing on the document data as the bit map. For example, the index information generating unit 13 sets the appearance bit to the appearance position of the bit map corresponding to the word ID, which is the result of encoding the word. Furthermore, in a case where the bit map corresponding to the word ID is not in the index information, the index information generating unit 13 may add the bit map corresponding to the word ID to the index information, and may set the appearance bit to the appearance position of the added bit map.

The document structure information generating unit 14 generates the document structure information in which the relationship with respect to the appearance position included in the index information is associated with each of the specific sub structures included in the document data, as the bit map. For example, when the index information is generated with respect to the word ID, the document structure information generating unit 14 determines whether or not the appearance position where the appearance bit is set with respect to the word ID is the head of the sub structure. In a case where the appearance position where the appearance bit is set with respect to the word ID is the head of the sub structure, the document structure information generating unit 14 sets the appearance bit to the appearance position of the bit map corresponding to the sub structure. Furthermore, examples of the sub structure include a file unit, a block unit, a chapter unit, a term unit, a clause unit, and the like.

The text mining unit 30 performs text mining based on the frequency aggregation result. The text mining represents that text data is quantitatively analyzed or useful information is taken out, and for example, represents that cluster analysis is performed, or measurement of a distance between documents (measurement of a similarity ratio) is performed. Examples of the similarity ratio used for the measurement of the distance between the documents include a Mahalanobis distance, a jaccard distance, or a cosine distance.

The preprocessing unit 20 is preprocessing for performing the text mining. The preprocessing unit 20 includes an aggregation granularity specifying unit 21 and a frequency aggregating unit 22.

In a case where measurement of a distance between the document data and the searching query is performed as an example of the text mining, the aggregation granularity specifying unit 21 specifies an aggregation granularity of a frequency aggregation. For example, the aggregation granularity specifying unit 21 performs the lexical analysis with respect to the searching query, and obtains the number of appearances of the words from the lexical analysis result. The aggregation granularity specifying unit 21 specifies the sub structure having the number of words close to the number of appearances of the words of the searching query as the aggregation granularity by using the bit map type index 43. As an example, the aggregation granularity specifying unit 21 obtains the number of words from the appearance bit to the next appearance bit with respect to sub structures of various granularities of the bit map type index 43, and specifies the sub structure having the number of words close to the number of appearances of the words of the searching query as the aggregation granularity.

The frequency aggregating unit 22 aggregates the frequencies of the words with the specified aggregation granularity by using the bit map type index 43. For example, the frequency aggregating unit 22 extracts a bit map with respect to the sub structure representing the aggregation granularity specified by the aggregation granularity specifying unit 21 from the bit map type index 43, and sets a bit in a section of the sub structure in the extracted bit map to ON (“1”). As an example, in a case where the sub structure representing the aggregation granularity is “chapter”, the frequency aggregating unit 22 sets a bit in a section of each chapter to ON (“1”) for each of the chapters. Then, the frequency aggregating unit 22 extracts a bit map with respect to a word of an aggregation target from the bit map type index 43. Then, the frequency aggregating unit 22 performs an AND operation with respect to the bit map with respect to the sub structure and the bit map with respect to the word of the aggregation target. Then, the frequency aggregating unit 22 sums up the number of bits of ON, and thus, aggregates the frequencies of the words included in the sub structure representing the aggregation granularity. Furthermore, the words of the aggregation target are all words included in the searching query, and may be all words represented by the word ID included in the bit map type index 43.

Example of Aggregation Granularity Specifying Processing

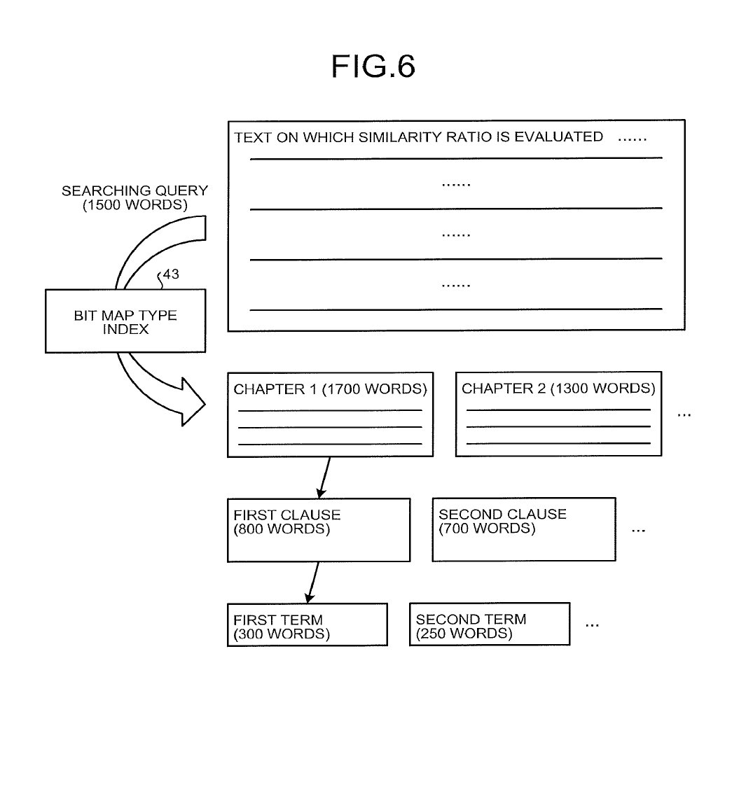

Here, an example of aggregation granularity specifying processing according to the first example will be described with reference to FIG. 6. FIG. 6 is a diagram illustrating an example of the aggregation granularity specifying processing according to the first example. Furthermore, in FIG. 6, the number of appearances of the words of the searching query is 1500. In addition, in the bit map type index 43, information of 1700 is set as the number of appearances of words in a first chapter, and information of 1300 is set as the number of appearances of words in a second chapter. In the first chapter, information of 800 is set as the number of appearances of words in a first clause, and information of 700 is set as the number of appearances of words in a second clause. In the first clause, information of 300 is set as the number of appearances of words in a first term, and information of 250 is set as the number of appearances of words in a second term.

Under such a circumstance, the aggregation granularity specifying unit 21 specifies the sub structure having the number of words close to the number of appearances of the words of the searching query as the aggregation granularity by using the bit map type index 43. Here, the number of appearances of the words of the searching query is 1500, and thus, the aggregation granularity specifying unit 21 specifies a sub structure of “chapter” close to the number of appearances of the words of the searching query as the aggregation granularity.

Example of Frequency Aggregation Processing

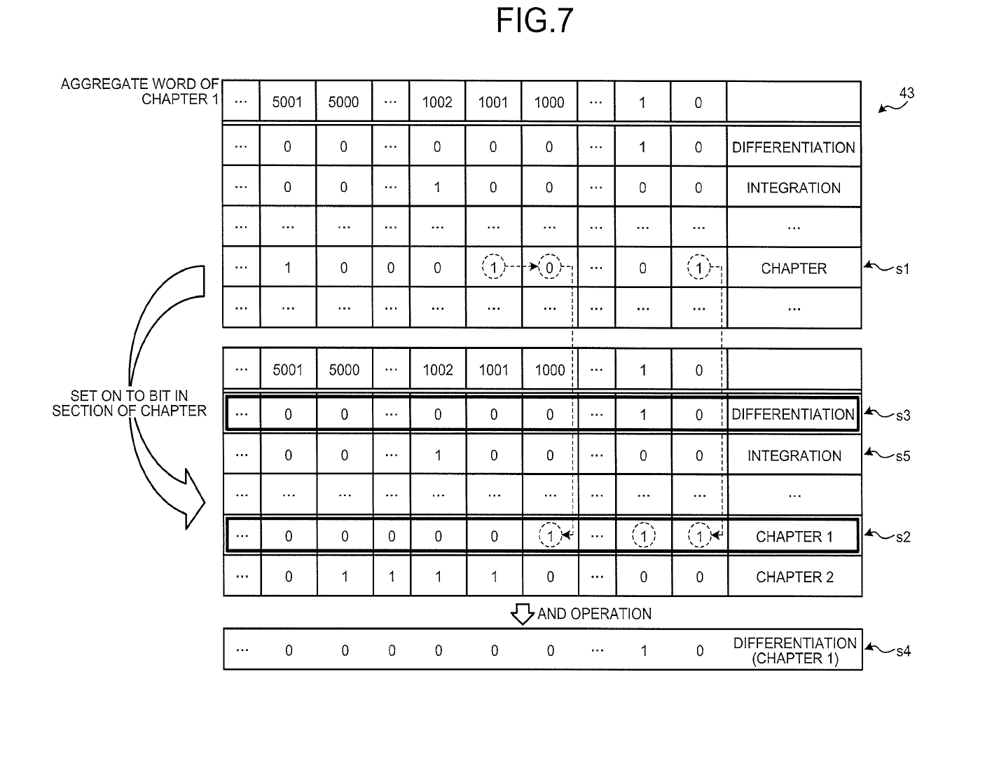

Here, an example of frequency aggregation processing according to the first example will be described with reference to FIG. 7. FIG. 7 is a diagram illustrating an example of the frequency aggregation processing according to the first example. Furthermore, “chapter” is specified as the aggregation granularity by the aggregation granularity specifying unit 21. FIG. 7 illustrates a case where the frequencies of the words included in the first chapter are aggregated.

As illustrated in FIG. 7, the frequency aggregating unit 22 extracts a bit map s1 with respect to the sub structure of “chapter” representing the aggregation granularity specified by the aggregation granularity specifying unit 21 from the bit map type index 43. Then, the frequency aggregating unit 22 sets a bit in a section of a sub structure of “first chapter” in the extracted bit map s1 to “1”. Here, as illustrated in the bit map of s2, the frequency aggregating unit 22 sets a section from the initial appearance bit of the bit map s1 with respect to “chapter” to a bit one before the next appearance bit to “1” as the section of “first chapter”. That is, a section from “0” to “1000” one before “1001” is set to “1” as the offset (the appearance position).

Then, the frequency aggregating unit 22 extracts a bit map s3 with respect to a word of “differentiation” of the aggregation target from the bit map type index 43. Then, the frequency aggregating unit 22 performs the AND operation with respect to the bit map s2 with respect to the sub structure of “first chapter” and the bit map s3 with respect to the word of the aggregation target. Here, an AND operation result is a bit map s4.

Then, the frequency aggregating unit 22 sums up the number of bits of “1”, and thus, aggregates the frequencies of the words included in the sub structure of “first chapter” representing the aggregation granularity. Here, the frequency aggregating unit 22 aggregates the number of bits in which “1” is set in the bits included in the bit map s4, and thus, is capable of aggregating the frequencies of the words of “differentiation” included in the sub structure of “first chapter”.

Similarly, the frequency aggregating unit 22 is capable of sub structure of aggregating the frequencies of the words of “integration” of the aggregation target included in “first chapter”. That is, the frequency aggregating unit 22 extracts a bit map s5 with respect to the word of “integration” of the aggregation target from the bit map type index 43. Then, the frequency aggregating unit 22 may perform the AND operation with respect to the bit map s2 with respect to the sub structure of “first chapter” and the bit map s5 respect to the word of the aggregation target, and may sum up the number of bits of “1”.

Furthermore, as with a case of “first chapter”, the frequency aggregating unit 22 may aggregate the frequencies of the words of the aggregation target included in “second chapter”.

Flowchart of Index Generating Processing According to First Example

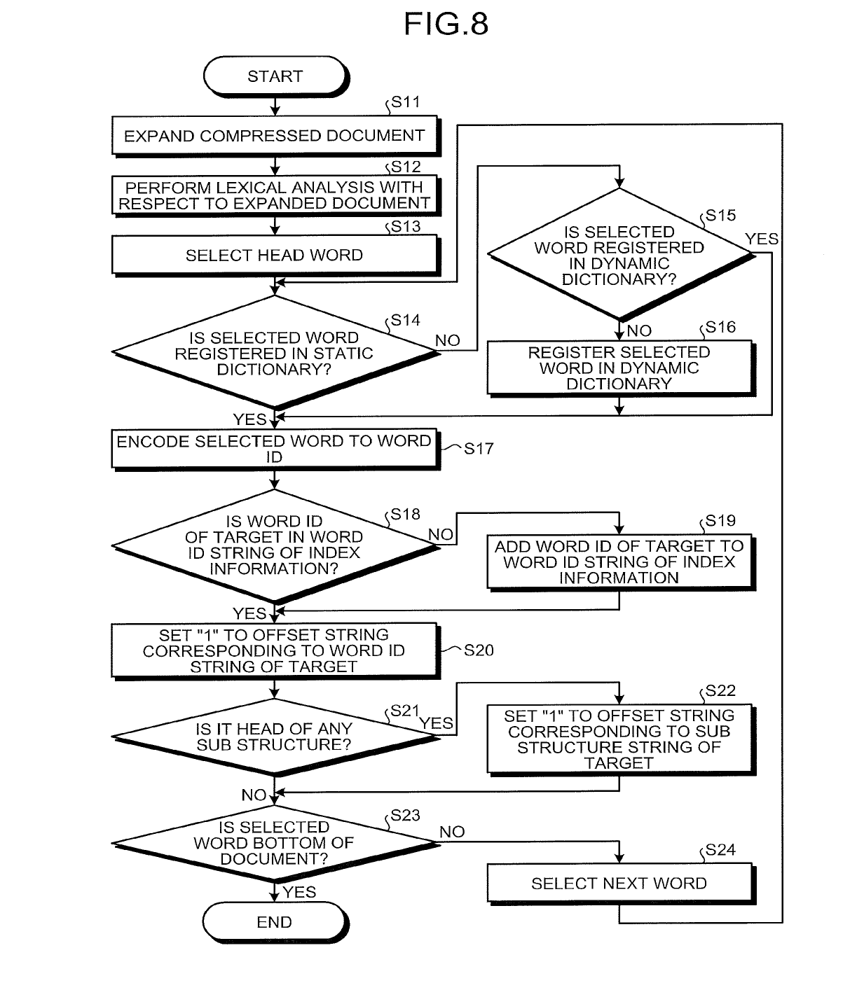

FIG. 8 is diagram illustrating an example of a flowchart of index generating processing according to the first example.

As illustrated in FIG. 8, the index generating processing unit 10 expands the compressed document data (Step S11). Then, the index generating processing unit 10 performs the lexical analysis with respect to the expanded document data (Step S12). Then, the index generating processing unit 10 selects the head word from the lexical analysis result (Step S13).

Subsequently, the index generating processing unit 10 determines whether or not the selected word is registered in the static dictionary 41 (Step S14). In a case where it is determined that the selected word is registered in the static dictionary 41 (Step S14; Yes), the index generating processing unit 10 allows the process to proceed to Step S17.

On the other hand, in a case where it is determined that the selected word is not registered in the static dictionary 41 (Step S14; No), the index generating processing unit 10 determines whether or not the selected word is registered in the dynamic dictionary 42 (Step S15). In a case where it is determined that the selected word is registered in the dynamic dictionary 42 (Step S15; Yes), the index generating processing unit 10 allows the process to proceed to Step S17.

On the other hand, in a case where it is determined that the selected word is not registered in the dynamic dictionary 42 (Step S15; No), the index generating processing unit 10 registers the selected word in the dynamic dictionary 42 (Step S16), and allows the process to proceed to Step S17.

In Step S17, the index generating processing unit 10 encodes the selected word to the word ID (Step S17). That is, in a case where it is determined that the selected word is registered in the static dictionary 41, the index generating processing unit 10 encodes the word to the word ID (the static code) by using the static dictionary 41. In a case where it is determined that the selected word is not registered in the static dictionary 41, the index generating processing unit 10 encodes the word to the word ID (the dynamic code) by using the dynamic dictionary 42.

Subsequently, the index generating processing unit 10 determines whether or not the word ID of the target is in an word ID string (a Y axis) of the index information of the bit map type index 43 (Step S18). In a case where it is determined that the word ID of the target is in the word ID string (the Y axis) of the index information (Step S18; Yes), the index generating processing unit 10 allows the process to proceed to Step S20.

On the other hand, in a case where it is determined that the word ID of the target is not in the word ID string (the Y axis) of the index information (Step S18; No), the index generating processing unit 10 adds the word ID of the target to the word ID string (the Y axis) of the index information (Step S19). Then, the index generating processing unit 10 allows the process to proceed to Step S20.

In Step S20, the index generating processing unit 10 sets “1” to an offset string corresponding to the word ID string of the target (Step S20). That is, the index generating processing unit 10 sets the appearance bit to the appearance position of the bit map corresponding to the word ID of the target.

The index generating processing unit 10 determines whether or not the offset string in which “1” is set is the head of any sub structure (Step S21). Here, the sub structure, for example, is a chapter, or is a term or a clause, but is not limited thereto. In a case where it is determined that the offset string in which “1” is set is the head of any sub structure (Step S21; Yes), the index generating processing unit 10 sets “1” to the offset string corresponding to a sub structure string of the target (Step S22). That is, the index generating processing unit 10 sets the appearance bit to the appearance position of the bit map corresponding to the sub structure of the target. Then, the index generating processing unit 10 allows the process to proceed to Step S23.

On the other hand, in a case where it is determined that the offset string in which “1” is set is not the head of any sub structure (Step S21; No), the index generating processing unit 10 allows the process to proceed to Step S23.

In Step S23, the index generating processing unit 10 determines whether or not the selected word is the bottom of the document (Step S23). In a case where it is determined that the selected word is not the bottom of the document (Step S23; No), the index generating processing unit 10 selects the next word (Step S24). Then, the index generating processing unit 10 allows the process to proceed to Step S14 in order to process the selected word.

On the other hand, in a case where it is determined that the selected word is the bottom of the document (Step S23; Yes), the index generating processing unit 10 ends the index generating processing.

Flowchart of Document Processing According to First Example

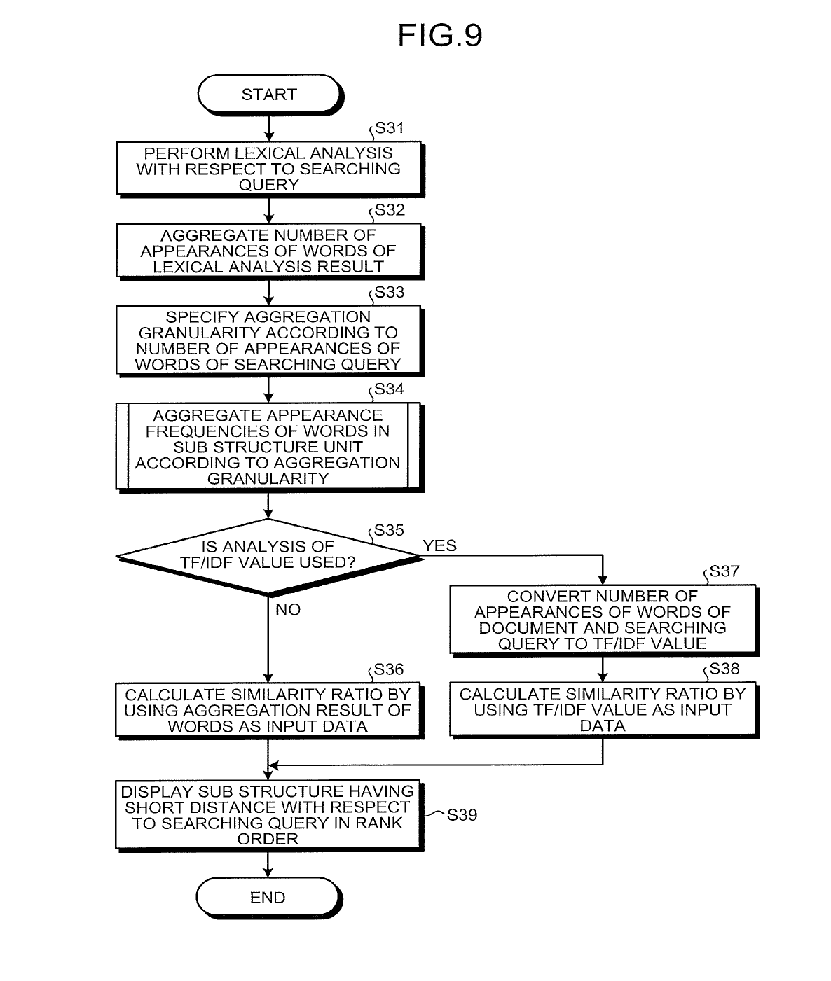

FIG. 9 is a diagram illustrating an example of a flowchart of document processing according to the first example. Furthermore, in the document processing of FIG. 9, a case of performing the measurement of the distance between the document and the searching query will be described as an example of the text mining.

As illustrated in FIG. 9, the preprocessing unit 20 performs the lexical analysis with respect to the searching query (Step S31). Then, the preprocessing unit 20 aggregates the number of appearances of the words of the lexical analysis result (Step S32).

Then, the preprocessing unit 20 specifies the aggregation granularity according to the number of appearances of the words of the searching query (Step S33). For example, the preprocessing unit 20 specifies the sub structure having the number of words close to the number of appearances of the words of the searching query as the aggregation granularity by using the bit map type index 43.

Then, the preprocessing unit 20 executes the frequency aggregation processing of aggregating the appearance frequencies of the words in the sub structure unit according to the specified aggregation granularity (Step S34). Furthermore, the flowchart of the frequency aggregation processing will be described below.

Subsequently, the text mining unit 30 determines whether or not the analysis of the TF/IDF value is used (Step S35). In a case where it is determined that the analysis of the TF/IDF value is not used (Step S35; No), the text mining unit 30 calculates the similarity ratio by using the aggregation result of the words as input data (Step S36). Then, the text mining unit 30 allows the process to proceed to Step S39.

On the other hand, in a case where it is determined that the analysis of the TF/IDF value is used (Step S35; Yes), the text mining unit 30 converts the number of appearances of the words of the document of the target and the searching query to the TF/IDF value (Step S37). Then, the text mining unit 30 calculates the similarity ratio by using the TF/IDF value as the input data (Step S38). Furthermore, examples of the similarity ratio include a Mahalanobis distance, a jaccard distance, or a cosine distance. In addition, the TF/IDF represents an important degree relevant to the word in the document, and is represented from a term frequency (TF) value representing the appearance frequency of the word in the document and an inverse document frequency (IDF) value representing that whether or not the word is commonly used in some documents. Then, the text mining unit 30 allows the process to proceed to Step S39.

In Step S39, the text mining unit 30 displays the sub structure having a short distance with respect to the searching query in rank order (Step S39). For example, in a case where the preprocessing unit 20 specifies “chapter” as the aggregation granularity, the text mining unit 30 displays the sub structures of “chapter” (Chapter 1, Chapter 2, . . . ) having a short distance with respect to the searching query in rank order. Then, the text mining unit 30 ends the document processing.

Flowchart of Frequency Aggregation Processing According to First Example

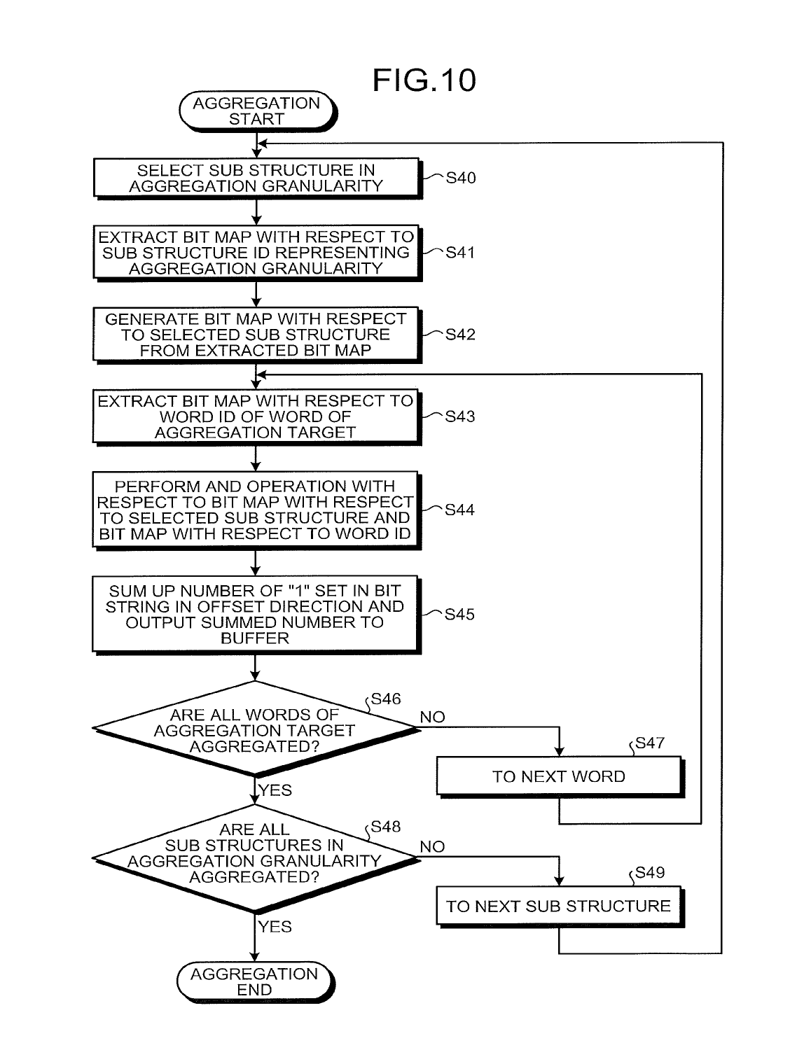

FIG. 10 is a diagram illustrating an example of the flowchart of the frequency aggregation processing according to the first example.

As illustrated in FIG. 10, the frequency aggregating unit 22 selects the sub structure in the specified aggregation granularity (Step S40). The frequency aggregating unit 22 extracts the bit map with respect to the sub structure ID representing the aggregation granularity from the bit map type index 43 (Step S41). Then, the frequency aggregating unit 22 generates the bit map with respect to the selected sub structure from the extracted bit map (Step S42). For example, the frequency aggregating unit 22 sets the bit in the section of the selected sub structure to “1” in the extracted bit map.

Subsequently, the frequency aggregating unit 22 extracts the bit map with respect to the word ID of the word of the aggregation target from the bit map type index (Step S43). Then, the frequency aggregating unit 22 performs the AND operation with respect to the bit map with respect to the selected sub structure and the bit map with respect to the word ID (Step S44).

The frequency aggregating unit 22 sums up the number of “1” set in a bit string in an offset direction with respect to the bit map of the operation result, and outputs the summed number to a buffer (Step S45). For example, the frequency aggregating unit 22 outputs the summed number to the buffer in association with the word of the aggregation target and the selected sub structure.

The frequency aggregating unit 22 determines whether or not all of the words of the aggregation target are aggregated (Step S46). In a case where it is determined that not all of the words of the aggregation target are aggregated (Step S46; No), the frequency aggregating unit 22 performs transition to the next word of the aggregation target (Step S47), and allows the process to proceed to Step S43.

On the other hand, in a case where it is determined that all of the words of the aggregation target are aggregated (Step S46; Yes), the frequency aggregating unit 22 determines whether or not all of the sub structures in the aggregation granularity are aggregated (Step S48). In a case where it is determined that not all of the sub structures in the aggregation granularity are aggregated (Step S48; No), the frequency aggregating unit 22 performs transition to the next sub structure in the aggregation granularity (Step S49), and allows the process to proceed to Step S40.

On the other hand, in a case where it is determined that all of the sub structures in the aggregation granularity are aggregated (Step S48; Yes), the frequency aggregating unit 22 ends the frequency aggregation processing.

### Effect of First Example

According to the first example described above, the information processing apparatus 1 generates the index information in which the appearance position is associated with each of the words appearing on the document data of the target, as the bit map data, at the time of encoding the document data of the target in the word unit. The information processing apparatus 1 generates the document structure information in which the relationship with respect to the appearance position included in the index information is associated with each of the specific sub structures included in the document data as the bit map data. Then, the information processing apparatus 1 retains the index information and the document structure information in the storage unit 40 in association with each other. According to such a configuration, in a case where the analysis is performed in the unit of the sub structure of the document data, it is possible for the information processing apparatus 1 to use the index information and the document structure information, which are the processing results of performing the processing in the document data unit. That is, even in a case where the analysis is performed by replacing the unit of the sub structure of the document data, the information processing apparatus 1 does not repeat the processing such as the lexical analysis of the document data in each case.

In addition, according to the first example described above, the information processing apparatus 1 sets the bit in the appearance positions of each of the words of the bit map data corresponding to each of the words for each of the words appearing on the document data, and thus, generates the index information. The information processing apparatus 1 sets the bit in the appearance positions of the head words of each of the sub structures of bit map data corresponding to each of the sub structures for each of the specific sub structures included in the document data, and thus, generates the document structure information. According to such a configuration, the information processing apparatus 1 uses the bits of the appearance positions of the index information and the document structure information, and thus, is capable of performing the analysis in various sub structures of each of the words.

In addition, according to the first example described above, the information processing apparatus 1 performs the logical operation using the bit map data of each of the words included in the index information and the bit map data of the specific sub structure included in the document structure information, and thus, aggregates the appearance frequencies of each of the words appearing on the specific sub structure. According to such a configuration, the information processing apparatus 1 uses the index information and the document structure information, and thus, even in a case where the unit of the sub structure is replaced, the processing such as the lexical analysis of the document data is not repeated in each case, and the appearance frequencies of each of the words can be aggregated in the replaced unit.

### Second Example

Here, the information processing apparatus 1 according to the first example specifies the aggregation granularity of the frequency aggregation in the document data by using all of the words of the searching query. Then, the information processing apparatus 1 aggregates the frequencies in the specified aggregation granularity, for example, the words included in the searching query as the aggregation target, by using the bit map type index 43. However, the information processing apparatus 1 is not limited thereto, and may specify the aggregation granularity of the frequency aggregation in the document data by using a feature word to be extracted from the searching query, and may aggregate the frequencies in the specified aggregation granularity by using the feature word to be extracted from the searching query as the aggregation target.

Therefore, in a second example, a case will be described in which the information processing apparatus 1 specifies the aggregation granularity of the frequency aggregation in the document data by using the feature word to be extracted from the searching query, and the frequencies are aggregated in the specified aggregation granularity by using the feature word to be extracted from the searching query as the aggregation target.

Configuration of Information Processing Apparatus According to Second Example

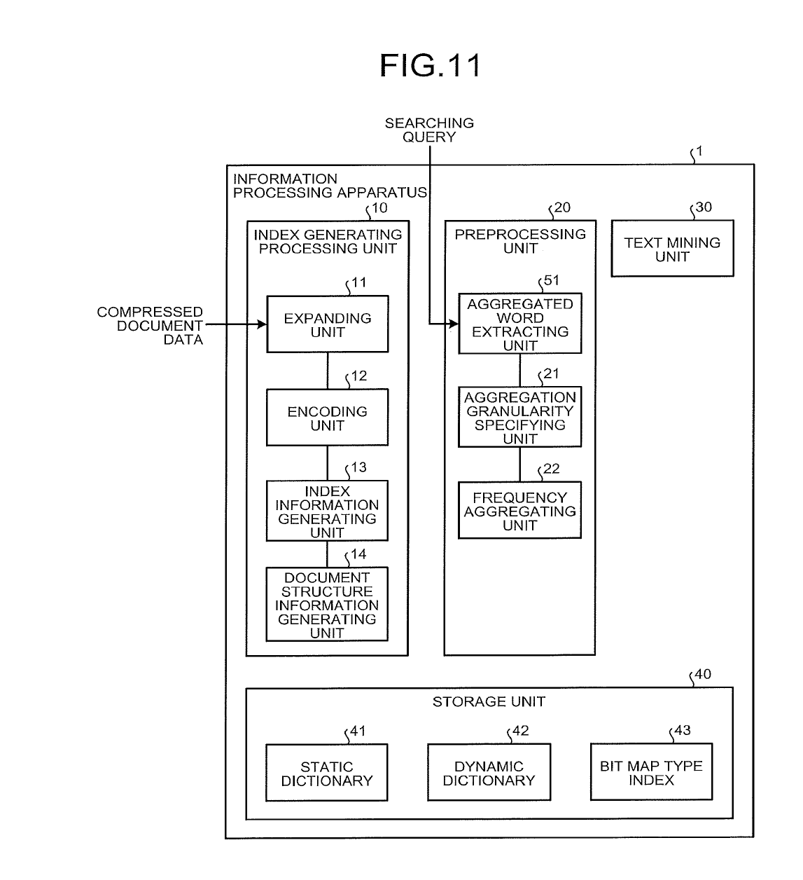

FIG. 11 is a functional block diagram illustrating the configuration of the information processing apparatus according to the second example. Furthermore, the same reference numerals are applied to the same configurations as those of the information processing apparatus 1 of the first example illustrated in FIG. 4, and thus, the repeated description of the same configuration and the same operation will be omitted. A difference between the first example and the second example is that an aggregated word extracting unit 51 is added.

The aggregated word extracting unit 51 extracts the word of the aggregation target from the searching query. For example, the aggregated word extracting unit 51 performs the lexical analysis with respect to the searching query, and aggregates the number of times of appearance of each of the words from the lexical analysis result. Then, the aggregated word extracting unit 51 calculates a feature amount of each of the words appearing on the searching query from the aggregation result and a plurality of document data items set in advance. The TF/IDF value may be used as the feature amount of the word. Then, the aggregated word extracting unit 51 extracts N (N: a natural number greater than 1) words, in which the feature amount is higher than a defined amount, as the feature word. The extracted feature word is a word which is used when the aggregation granularity is specified by the aggregation granularity specifying unit 21, and is the word of the target to be aggregated by the frequency aggregating unit 22. Furthermore, N may be set in advance by the user.

Example of Preprocessing

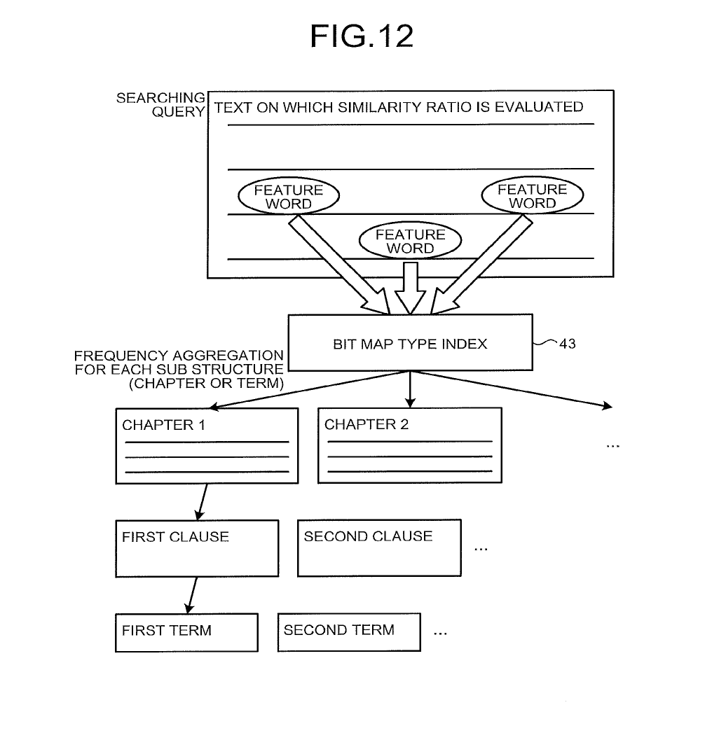

Here, an example of preprocessing according to the second example will be described with reference to FIG. 12. FIG. 12 is a diagram illustrating an example of the preprocessing according to the second example. Furthermore, in FIG. 12, the aggregated word extracting unit 51 extracts N feature words from the searching query.

Under such a circumstance, the aggregation granularity specifying unit 21 specifies the sub structure having the number of words close to the number of appearances of N feature words of the searching query as the aggregation granularity by using the bit map type index 43. Then, the frequencies of the feature words are aggregated in the specified aggregation granularity by using the bit map type index 43.

Flowchart of Document Processing According to Second Example

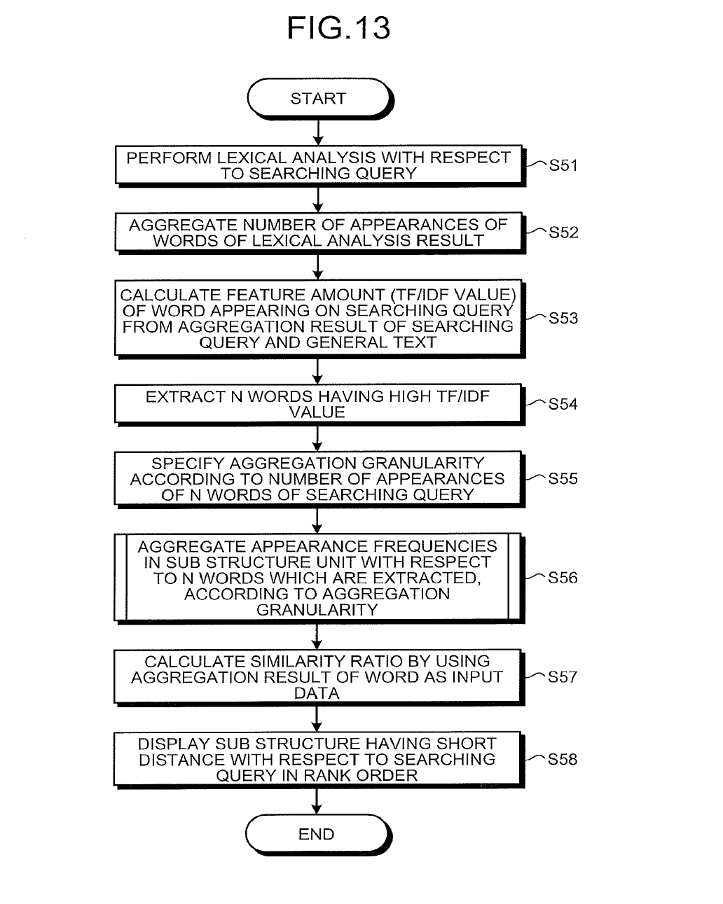

FIG. 13 is a diagram illustrating an example of a flowchart of document processing according to the second example. Furthermore, in the document processing of FIG. 13, a case will be described in which the measurement of the distance between the document and the searching query is performed as an example of the text mining.

As illustrated in FIG. 13, the preprocessing unit 20 performs the lexical analysis with respect to the searching query (Step S51). Then, the preprocessing unit 20 aggregates the number of appearances of the words of the lexical analysis result (Step S52).

Then, the preprocessing unit 20 calculates the feature amount (the TF/IDF value) of the word appearing on the searching query from the aggregation result of the searching query and a general text (Step S53). Then, the preprocessing unit 20 extracts N words having a high TF/IDF value as the feature word (Step S54).

Then, the preprocessing unit 20 specifies the aggregation granularity according to the number of appearances of N words of the searching query (Step S55). For example, the preprocessing unit 20 specifies the sub structure having the number of words close to the number of appearances of N feature words of the searching query as the aggregation granularity by using the bit map type index 43.

Then, the preprocessing unit 20 executes the frequency aggregation processing of aggregating the appearance frequencies of the words in the sub structure unit with respect to N words which are extracted, according to the specified aggregation granularity (Step S56). The words of the aggregation target are N words which are extracted. Furthermore, the flowchart of the frequency aggregation processing is identical to that described in FIG. 10, and thus, the description thereof will be omitted.

Subsequently, in a case where the analysis of the TF/IDF value is not used, the text mining unit 30 calculates the similarity ratio by using the aggregation result of the word as the input data (Step S57). Examples of the similarity ratio include a Mahalanobis distance, a jaccard distance, or a cosine distance. Then, the text mining unit 30 displays the sub structure having a short distance with respect to the searching query in rank order (Step S58). For example, in a case where the preprocessing unit 20 specifies “chapter” as the aggregation granularity, the text mining unit 30 displays the sub structures of “chapter” (Chapter 1, Chapter 2, . . . ) having a short distance with respect to the searching query in rank order. Then, the text mining unit 30 ends the document processing.

### Effect of Second Example

According to the second example described above, when it is determined whether or not the document data of the searching target is similar to the document data of the target, the information processing apparatus 1 calculates the feature amount of the word appearing on the document data of the searching target, and extracts a plurality of words having a feature amount greater than the defined amount based on the feature amount. Then, the information processing apparatus 1 aggregates the appearance frequencies of each of the plurality of extracted words by using the index information and the document structure information. According to such a configuration, the information processing apparatus 1 aggregates the appearance frequencies with respect to the document data of the target in a plurality of feature words included in the document data of the searching target, and thus, is capable of further accelerating the aggregation processing of the appearance frequency in a case of performing the analysis in the unit of the sub structure of the document data of the target.

Others

Furthermore, in the document processing according to the first example, it has been described that in a case where the compression and expansion algorithm is ZIP, the expanding unit 11 expands the compressed document data. However, the compression and expansion algorithm is not limited to ZIP, and may be an algorithm using the static dictionary 41 and the dynamic dictionary 42. That is, the expanding unit 11 may expand the compressed document data by using the static dictionary 41 and the dynamic dictionary 42. In such a case, the encoding unit 12 may perform the encoding by using the static dictionary 41 and the dynamic dictionary 42 which is generated in the compression processing in advance.

In addition, in the first example, it has been described that the encoding unit 12 performs the lexical analysis with respect to the expanded document data by using the dictionary for lexical analysis. However, the encoding unit 12 is not limited thereto, and may perform the lexical analysis with respect to the expanded document data as the dictionary for lexical analysis by using the static dictionary 41 and the dynamic dictionary 42.

In addition, each constituent of the illustrated apparatus is not needed to be physically configured according to the drawings. That is, a specific aspect of the dispersion and integration of the apparatus is not limited to the drawings, and all or a part of the apparatus can be functionally or physically dispersed or integrated in arbitrary unit according to various loads, use circumstances, or the like. For example, the encoding unit 12 and the index information generating unit 13 may be integrated. In addition, the encoding unit 12 may be divided into a first encoding unit encoding a word to a static code and a second encoding unit encoding a word to a dynamic code. In addition, the storage unit 40 may configured as an external apparatus of the information processing apparatus 1 and may be connected to the information processing apparatus 1 through a network.

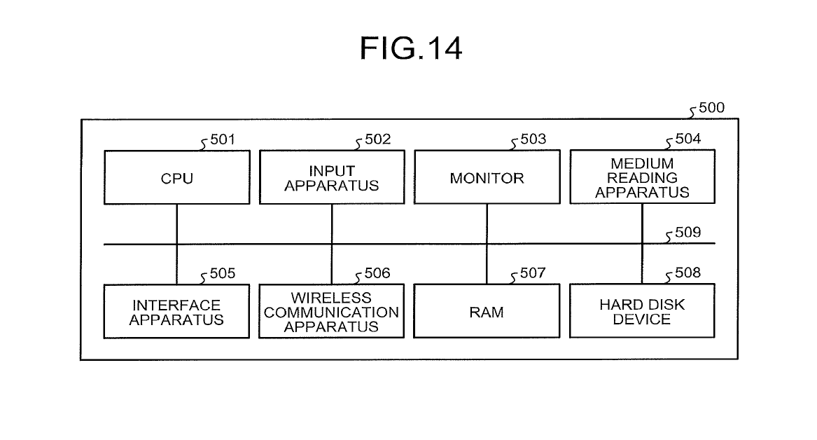

FIG. 14 is a diagram illustrating an example of a hardware configuration of the information processing apparatus. As illustrated in FIG. 14, a computer 500 includes a CPU 501 executing various operation processing, an input apparatus 502 receiving a data input from the user, and a monitor 503. In addition, the computer 500 includes a medium reading apparatus 504 reading a program or the like from a storage medium, an interface apparatus 505 for being connected to other apparatuses, and a wireless communication apparatus 506 for being connected to the other apparatuses in a wireless manner. In addition, the computer 500 includes a random access memory (RAM) 507 temporarily storing various information items, and a hard disk device 508. In addition, each of the apparatuses 501 to 508 is connected to a bus 509.

A document encoding program having the same function as that of the index generating processing unit 10, the preprocessing unit 20, and the text mining unit 30, illustrated in FIG. 4, is stored in the hard disk device 508. In addition, various data items for realizing the document encoding program are stored in the hard disk device 508. The various data items include the data in the storage unit 40 illustrated in FIG. 4.

The CPU 501 executes each of the programs stored in the hard disk device 508 by reading out the programs and by decompressing the programs in an RAM 507, and thus, performs various processing. Such programs allow the computer 500 to function as each function unit illustrated in FIG. 4.

Furthermore, the document encoding program described above is not needed to be stored in the hard disk device 508. For example, a program stored in a storage medium which can be read by the computer 500, may be read out and executed by the computer 500. The storage medium which can be read by the computer 500, for example, corresponds to a portable recording medium such as a CD-ROM, a DVD disk, or a universal serial bus (USB) memory, a semiconductor memory such as a flash memory, a hard disk drive, and the like. In addition, the program may be stored in an apparatus connected to a public line, the internet, a local area network (LAN), and the like, and the computer 500 may read out the program from the apparatus and may execute the program.

According to a first embodiment of the present invention, in a case where analysis is performed in the unit of a sub structure of a document, it is possible to use a processing result of performing processing in document unit.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a document encoding program that causes a computer to execute a process comprising:
first generating index information in which an appearance position is associated with each word appearing on document data of a target as bit map data at the time of encoding the document data of the target in word unit;
second generating document structure information in which a relationship with respect to the appearance position included in the index information is associated with each specific sub structure included in the document data as bit map data; and
retaining the index information and the document structure information in a storage in association with each other.

2. The computer-readable recording medium according to claim 1, wherein
the first generating includes generating the index information by setting a bit in an appearance position of each word of bit map data corresponding to each word, for each of the words appearing in the document data, and
the second generating includes generating the document structure information by setting a bit in an appearance position of a head word of each sub structure of bit map data corresponding to each sub structure, for each of the specific sub structures included in the document data.

3. The computer-readable recording medium according to claim 1, wherein the process further includes aggregating appearance frequencies for each word appearing on the specific sub structure by a logical operation using the bit map data of each of the words included in the index information which is retained in the storage and the bit map data of the specific sub structure included in the document structure information which is retained in the storage.

4. The computer-readable recording medium according to claim 3, wherein the aggregating includes aggregating the appearance frequencies of each of the words appearing on the specific sub structure by setting a bit in each of the words appearing on the specific sub structure by using the bit map data.

5. The computer-readable recording medium according to claim 3, wherein
the process further includes specifying a sub structure having the number of words close to the number of words included in document data of a searching target by using the index information and the document structure information when it is determined whether or not the document data of the searching target is close to the document data of the target, and
the aggregating includes aggregating the appearance frequencies of each of the words appearing on the specified sub structure by using the index information and the document structure information.

6. The computer-readable recording medium according to claim 4, wherein
the process further includes calculating a feature amount of a word appearing on the document data of the searching target when it is determined whether or not the document data of the searching target is close to the document data of the target, and extracting a plurality of words having a feature amount greater than a defined amount based on the feature amount, and
the aggregating includes aggregating appearance frequencies of each of a plurality of words appearing on the specified sub structure, which is each of the plurality of extracted words, by using the index information and the document structure information.

7. An information processing apparatus comprising:
a processor configured to:
generate index information in which an appearance position is associated with each word appearing on document data of a target as bit map data at the time of encoding the document data of the target in word unit;
generate document structure information in which a relationship with respect to the appearance position included in the index information is associated with each specific sub structure included in the document data as bit map data; and
retain the index information and the document structure information in a storage in association with each other.

8. A document encoding method comprising:
first generating index information in which an appearance position is associated with each word appearing on document data of a target as bit map data at the time of encoding the document data of the target in word unit, by a processor;
second generating document structure information in which a relationship with respect to the appearance position included in the index information is associated with each specific sub structure included in the document data as bit map data, by the processor; and
retaining the index information and the document structure information in a storage in association with each other.
